(19) United States
(12) Patent Application Publication
(10) Pub. No.: US 2014/0084036 A1
(43) Pub. Date: Mar. 27, 2014

(54) Cart Tray

(71) Applicant: Scott Hemann, Florence, SC (US)

(72) Inventor: Scott Hemann, Florence, SC (US)

(21) Appl. No.: 13/628,451

(22) Filed: Sep. 27, 2012

(51) Int. Cl. B62B 5/00

(52) U.S. Cl. CPC B62B 5/00
USPC 224/411

(57) ABSTRACT

A tray or basket is provided for a cart as used in home improvement stores. The tray includes means for attaching the tray to the cart and for stabilizing the tray thereon.

### BACKGROUND OF THE DISCLOSURE

Most home improvement stores provide carts for carrying large merchandise such as lumber, five gallon buckets and the like. However, customers also typically place smaller items for purchase on the cart with the larger merchandise. Since the cart is designed to transport larger merchandise and not equipped to carry the smaller items, the smaller items often fall from the cart during shopping. These falls may result in product loss from breakage and safety hazards from ensuing spills, broken glass and the like.

Stores may also provide conventional shopping carts for smaller items, but most customers who need both larger and smaller items typically will not attempt to push two carts while shopping. Moreover, maintaining a fleet of smaller conventional shopping carts increases store overhead, which is often passed on to the consumer in the form of higher prices.

What is needed in the home improvement industry is a system to reduce cart inventory and make remaining carts more accommodating for all types of store merchandise.

### BRIEF SUMMARY OF THE DISCLOSURE

The present disclosure is directed in general to trays or baskets for carts used in retail home improvement stores. The trays are simple to manufacture, install and use.

For example, in an embodiment according to the present disclosure, a tray for a cart may include a basket having a floor, a rear wall, a front wall, a first side wall and a second side wall. This aspect may include a hook, such as a loop, connected to the basket and extending therefrom for attachment to the cart, such as via an attachment plate or mounting bracket. In this aspect of the disclosure, a stop may also be provided having a proximal end and a distal end. The proximal end may be connected to the basket, and the distal end may extend from the basket for engagement with a portion of the cart to restrict movement of the basket relative to the cart. The basket may be made of wire mesh or plastic or metal panels. The front wall and the rear wall may have different heights. In one aspect, the first or the second side walls may be angled.

In another aspect of the disclosure, a tray for a cart may include a basket having a hook attached to the basket. The hook may extend at an angle from the basket for attachment to the cart. A stop or bumper may be provided having a proximal end and a distal end. The proximal end may be connected to the basket. The distal end may extend from the basket for engagement with a portion of the cart to restrict movement of the basket relative to the cart. In this exemplary embodiment, the basket may be made from wire mesh and may be powder coated. In this aspect, a floor of the basket may be steel mesh, or the floor may be a panel.

In another aspect of the disclosure, a bar may be provided that is attachable to a cart. A tray or carrier may hang over the bar and/or be affixed to the bar. In yet another aspect, the tray may include a gate or a portion of a wall that can be opened to gain access to an interior of the basket.

Additional aspects of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of such variations upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of a cart tray being employed in an intended use environment according to an aspect of the disclosure;

FIG. 2 is a perspective view of a cart tray according to another aspect of the disclosure being employed in an intended use environment;

FIG. 3 is a perspective view of a cart tray according to another embodiment of the disclosure;

FIG. 4 is a perspective view of a cart tray according to a further embodiment of the disclosure; and

FIG. 5 is a perspective view of a cart tray and cross bar according to a further embodiment of the disclosure.

### DETAILED DESCRIPTION OF THE DISCLOSURE

Detailed reference will now be made to the drawings in which examples embodying the present subject matter are shown. The detailed description uses numerical and letter designations to refer to features of the drawings. Like or similar designations of the drawings and description have been used to refer to like or similar parts of various exemplary embodiments.

The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed description are provided by way of explanation only and are not meant as limitations of the disclosure. The present subject matter thus includes any modifications and variations of the following examples as come within the scope of the appended claims and their equivalents.

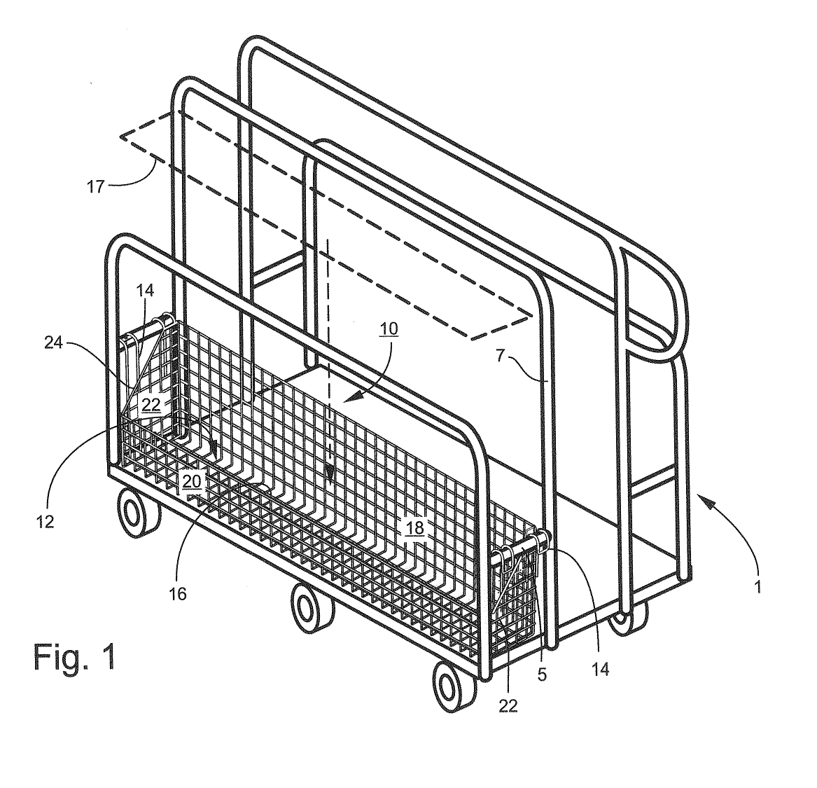

Turning now to FIG. 1, a wheeled lumber cart 1 common to retail home improvement centers is equipped with an exemplary tray or carrier designated in general by the number 10. As shown in this example, the carrier 10 is disposed on horizontally oriented, one and one-quarter inch (1¼″) metal bars or rails 5 connected to similar but vertically oriented bars 7 of the cart 1. The carrier 10 broadly includes a basket 12 with clips, hangars or hooks 14, a bottom or floor 16, a first (rear or back) face or wall 18, a second (front or outside) face or wall 20, and side walls or gates 22. As shown, the side walls 22 may each define an angle 24 that slopes from the rear wall 18 to the front wall 20 or vice versa. The angle 24 provided in this example causes the front wall 20 to be about six inches (6″) high to permit customer access to the interior of the basket 12 even when a large article such as lumber (not shown) is stacked across the end rails 5 the cart 1.

FIG. 1 also shows that the various components of the carrier 10 may be made from wire mesh to form an open grid pattern. Specifically, the basket 12 as well as its hangars 14, the floor 16, the rear wall 18, the front wall 20, and the side walls 22 may be made of metal and may be powder-coated to provide durability and to protect items that are placed in the basket 12. The open grid pattern provided by the wire mesh construction will, for instance, prevent liquids or trash from collecting in the basket 12, which—by presenting a clean appearance to customers—is more likely to encourage repeated use of the cart 1 and the carrier 10. However, it will be understood that any or all of the various walls and floor of the basket 12 may be formed from a solid sheet of plastic or metal, depending on store requirements. For instance, it may be desirable in some cases to provide a solid floor 16 or to place an insert 17 (shown in phantom for clarity) over the wire mesh floor 16 to accommodate extremely small items.

While lumber carts provided by different manufacturers may vary slightly in size, the carrier 10 shown in FIG. 1 is universal in order to fit most carts like cart 1. In this example, the basket 12 of the carrier 10 is generally rectangular and measures approximately 6¾″ deep×48″ wide×13¾″ tall with a 6″ high front, as introduced above.

The basket 12 shown in FIG. 1 provides an easy access space to hold multiple smaller items for purchase while carrying larger merchandise that the cart 1 was designed to transport. The basket 12 further serves to contain the smaller items that routinely fall on the store floor while moving the cart 1 around the store. Falling products not only inconvenience the customer who has to pick up the fallen items, but these spills can cause product loss due to breakage. Thus, the basket 12 also improves safety by reducing spills and broken glass and the like that would ordinarily occur as a result of the products falling from the cart 1 when not equipped with the carrier 10. Still further, because the carrier 10 increases the functionality of the cart 1 by adapting the cart 1 to carry both larger merchandise such as lumber and smaller items like light bulbs and hand tools, home improvement warehouses may be able to reduce their inventory of conventional shopping carts and enjoy an attendant reduction in overhead that a larger fleet of shopping carts requires.

Also shown in the embodiment of FIG. 1, the tray 10 has no moving parts so it is relatively easy to manufacture and relatively sturdy. Further, the tray 10 can be mounted to the rails 5 using screws, bolts or the like via, for instance, the hangars 14. As shown, the hangars 14 are sufficiently spaced apart from the side walls 22 to fit over the rails 5 for easy installation and removal, as desired. in this example, the hangars 14 may be two shepherd hook clips extending from each side wall 22. If desired, the tray 10 can be permanently attached to the cart 1, for instance, by spot welding the hangars 14 to the rails 5.

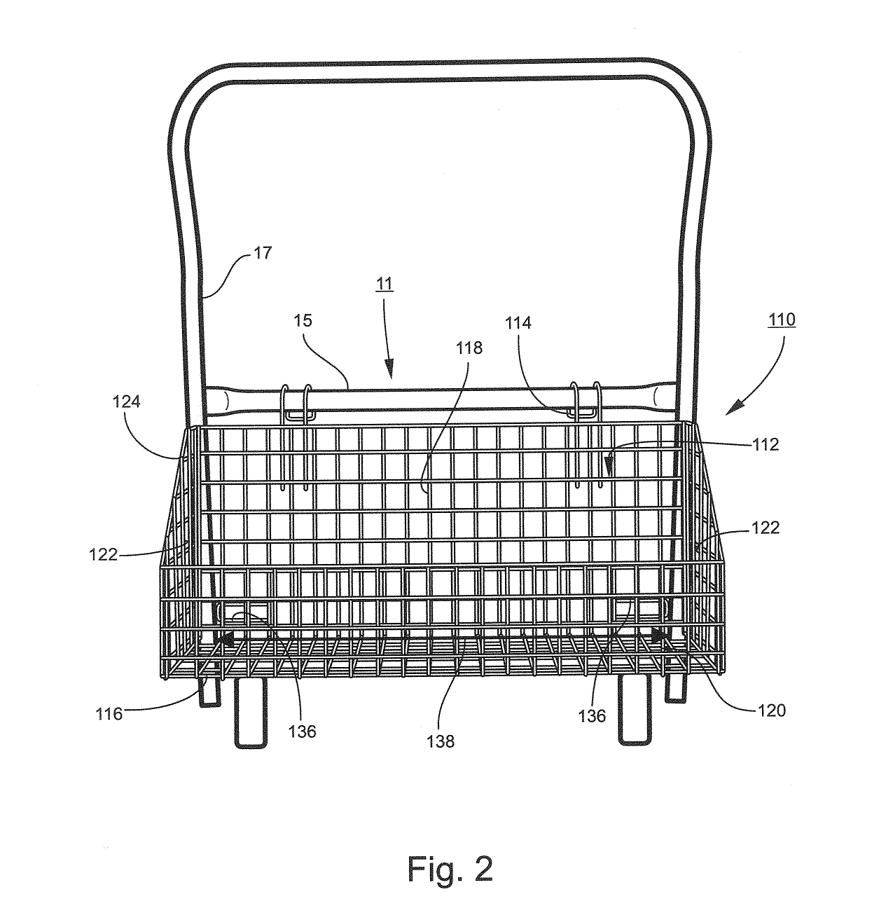

FIG. 2 shows another embodiment according to the present disclosure. Here, a wheeled flat cart 11 common to retail home improvement warehouses and stores is equipped with an exemplary tray or carrier designated in general by the number 110. As shown in this example, the carrier 110 is disposed on horizontally oriented, one and one-quarter inch (1¼″) metal bar or rail 15 connected to similar but vertically oriented bars 17 of the cart 11. The carrier 110 broadly includes a basket or cart 112 having clips, hangars or hooks 114, a bottom or floor 116, a first (rear or back) face or wall 118, a second (front or outside) face or wall 120, and side walls or gates 122. As shown, the side walls 122 may define an angled top 124 that slopes from the rear wall 118 to the front wall 120 or vice versa. The angle 124 may be provided, for instance, to permit easier access to the interior of the basket 112 so that a customer does not have to reach over a relatively higher front wall 120 to insert or remove items from the basket 112.

In the example shown in FIG. 2, the basket 112 and its component parts may be made from metal wire mesh, such as steel, to form an open grid pattern. Among other things, the open grid permits easy cleaning of the carrier 110 and increases visibility of items in the basket 112. Also shown, the hangars 114 are shepherd hook clips mounted on the rear wall 118 in order for the basket 112 to be drop-mounted onto the 1¼ inch rounded cross bar 15 of the cart 11. It will be appreciated that the basket 112 can hang on the bar 15 facing either forward (as shown) or rearward. Furthermore, the basket 112 may be mounted permanently or semi-permanently to the bar 15 using, for instance, screws, bolts, welds, and the like.

FIG. 2 further shows that the basket 112 may include stops or bumpers 136 attached, in this example, to the wall 118. As shown, the bumpers 136 are spaced sufficiently between the bars 17 of the cart 11. In use, if the hangars 114 are not bolted or otherwise connected to the bar 15, the bumpers 136 will serve to reduce side-to-side movement of the carrier 110, as indicated by the double-headed arrow 138. It will be appreciated that although the bumpers 136 in this example are spot welded at a pre-selected distance from their respective bars 17 based on a standard cart size, bumpers 136 can be provided that are adjustable to accommodate carts with bars spaced at distances other than that shown in FIG. 2.

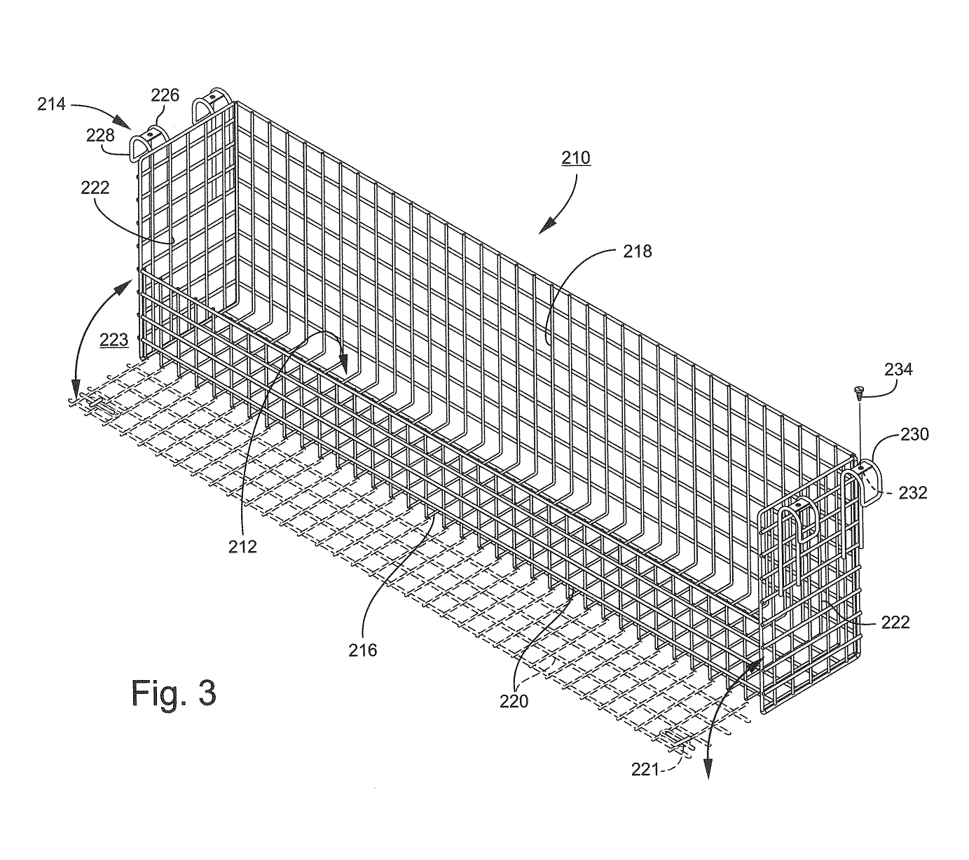

With reference now to FIG. 3, in another embodiment according to the disclosure, a carrier 210 is provided with a basket 212 having clips, hangars or hooks 214, a bottom or floor 216, a first (rear or back) face or wall 218, a second (front or outside) face or wall 220, and side walls or gates 222. In this example, the side walls 222 have the same height of the rear wall 218 while the front wall 220 is about one-third to one half the height of the rear wall 218 and the side walls 222. The rectangular shaped side walls 222 may increase the security of smaller items in the basket 212 and/or increase the capacity of the basket 212 while still permitting customer relatively easy access to the interior of the basket 212.

Also shown in FIG. 3, each of the hooks 214 include a horizontally oriented section 226 that folds into a downwardly depending vertical section 228 to form each hook 214. The hooks 214 are capable of hanging the basket 212 on end rails of a cart such as the rails 5 of the cart 1 described above and shown in FIG. 1. In this example, each of the hooks 214 include mounting plates 230 attached proximate the horizontally oriented sections 226. Each of the mounting plates 230 may include a hole therein such as aperture 232 through which a screw or bolt 234 may be inserted into cart rails, such as the bar 5, noted above. If a more permanent fixture is desired, the mounting plates 230 may be welded to the cart rails.

FIG. 3 further shows that one of the walls 218, 220, 222 or portions thereof, can be made to open and close. In this example, the front wall 220 is equipped with a spring, hook or latch mechanism 221. When activated, the mechanism 221 will allow a shopper to release and/or raise the wall 220 and rotate it outward as indicated by the double-headed arrow 223. This is useful, for instance, to empty smaller items from the basket 212 at a check-out counter. For clarity, the wall 220 in its released state is shown in phantom in FIG. 3.

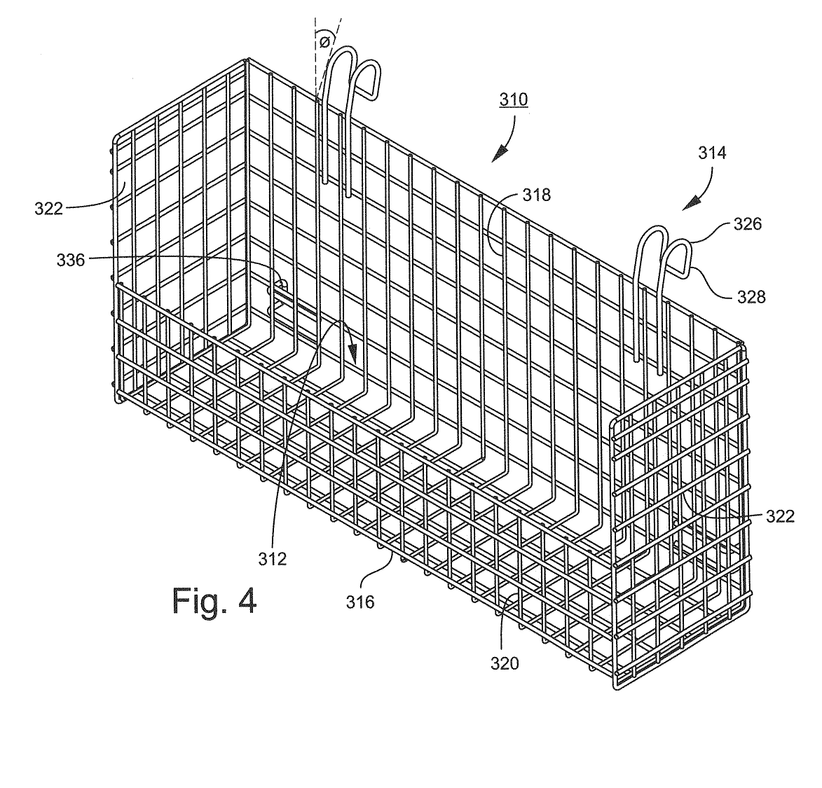

FIG. 4 shows an additional embodiment according to the present disclosure. In this example, a carrier 310 broadly includes a basket or cart 312 having clips, hangars or hooks 314, a bottom or floor 316, a first (rear or back) face or wall 318, a second (front or outside) face or wall 320, and side walls or gates 322. Here, the side walls 322 may have the same height as that of the rear wall 318 while the front wall 320 is about one-third to one half the height of the rear wall 318 and the side walls 322.

FIG. 4 further shows that each of the clips 314 include a horizontally oriented section 326 that bends downwardly into a vertical section 328 to form each hook 314. The hooks 314 are capable of hanging the basket 312 on cross bars of most carts, such as the rail 15 of the cart 11 described above and shown in FIG. 2. In the example shown in FIG. 4, each of the hooks 314 are angled away from the rear wall 318 at an angle designated in general by the symbol φ. The angle φ may be from about ten degrees to about thirty degrees from vertical or the rear wall 318, in this example. The angle φ, along with bumpers 336, helps maintain the basket 312 in a stable position to keep the basket 312 from sliding side to side or to inhibit a bouncing motion as the cart is moved about a store while shopping.

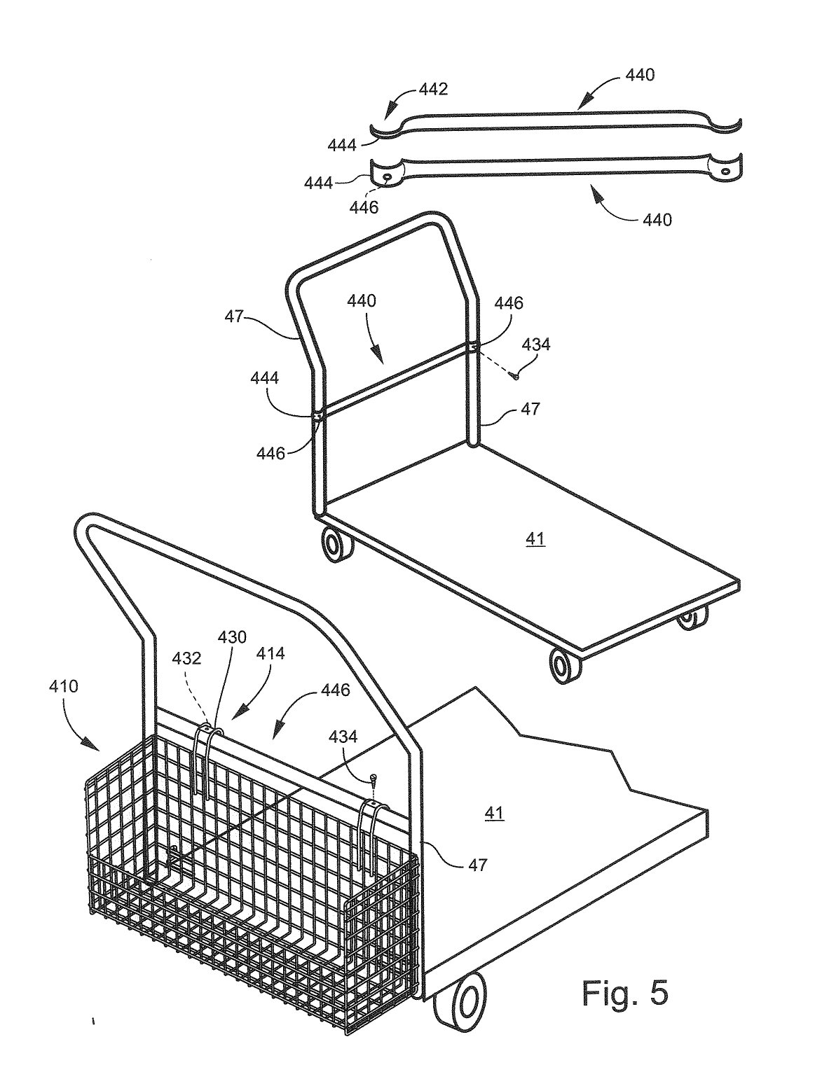

In most cases, carts such as cart 41 shown in FIG. 5 are twenty-four (24) or thirty (30) inches wide. A universal carrier 410 is provided for these standard widths and will hang on a cross bar of most carts (see, e.g., rail 15 of cart 11 in FIG. 2). However, the carrier 410 can be manufactured to accommodate non-standard widths and can be made to attach to other rails or bars if a cart does not include a rail. For instance, if the cart 41 as shown in FIG. 5 is not equipped with a horizontal rail, a rail or crossbar 440 can be provided according to another aspect of the present disclosure. As shown, the crossbar 440 may be attached or affixed to vertical bars 47 of the cart 41. More particularly, in the side and elevational views at the top of FIG. 5, the exemplary crossbar 440 is generally cylindrical and approximately one and one quarter inch (1¼ in.) in diameter. At either end 442 of the crossbar 440 an attachment mechanism or structure 444 is provided, which is shaped to complement the vertical bars 47 of the cart 41. Here, the ends 442 are formed by crimping the crossbar 440 to form claws or cup-shaped structures 444 with holes 446 through which bolts, cotter pins, anchors and the like, such as screws 434, may be used to fasten the crossbar 440 to the cart 41.

As further shown in FIG. 5, once the crossbar 440 is positioned between the vertical bars 47 of the cart 41, the carrier 410 can be hung over the crossbar 440 using hooks or hangars 414. In this example, the hangars 414 can include portions such as plates or tabs 430 that may have holes or apertures 432 through which screws or bolts 434 may be inserted to affix the hangars 414 to the crossbar 440. Although the exemplary crossbar 440 has been shown by example with half-moon shaped ends 444, it will understood that the ends 444 could be press-fit between the bars 47 of the cart 41 or otherwise attached, such as by welding. Thus, the accessory crossbar 440 is not limited to the exemplary features in FIG. 5.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A tray for a cart comprising:
a basket having a floor, a rear wall, a front wall, a first side wall and a second side wall;
a hook connected to the basket and extending therefrom for attachment to the cart; and
a stop having a proximal end and a distal end, the proximal end connected to the basket, the distal end depending from the basket for engagement with a portion of the cart to restrict movement of the basket relative to the cart.

2. The tray as in claim 1, wherein the basket is made of wire mesh or plastic or metal panels.

3. The tray as in claim 1, wherein the front wall and the rear wall differ in height.

4. The tray as in claim 3, wherein the first side wall or the second side wall are angled.

5. The tray as in claim 1, wherein the hook is a loop.

6. The tray as in claim 1, further comprising a mounting plate attached to the hook, the mounting plate being configured for attachment to the cart.

7. A tray for a cart comprising:
a basket including a hook attached to the basket, the hook extending therefrom for attachment to the cart; and
a stop having a proximal end and a distal end, the proximal end connected to the basket, the distal end depending from the basket for engagement with a portion of the cart to restrict movement of the basket relative to the cart.

8. The tray as in claim 7, wherein the basket is wire mesh.

9. The tray as in claim 8, wherein the wire mesh is powder coated.

10. The tray as in claim 7, wherein the hook is angled away from the basket.

11. The tray as in claim 7, wherein the basket includes a side wall interposed between a first wall and a second wall.

12. The tray as in claim 11, wherein the first wall and the second wall have different heights.

13. The tray as in claim 12, wherein the side wall is angled between the first wall and the second wall.

14. The tray as in claim 7, wherein the basket includes a floor, the floor being one of a wire mesh or a panel.

15. The tray as in claim 7, wherein the basket includes a floor, the floor being one of a wire mesh or a panel.

16. The tray as in claim 7, further comprising a mounting plate.

17. The tray as in claim 16, wherein the mounting plate is attachable to the cart by one of a screw, a bolt or a weld.

18. A tray for a cart comprising:
a basket having a floor, a rear wall, a front wall, a first side wall and a second side wall;
means for attaching the basket to the cart; and
a stop having a proximal end and a distal end, the proximal end connected to the basket, the distal end depending from the basket for engagement with a portion of the cart to restrict movement of the basket relative to the cart.

19. The tray as in claim 18, wherein the means for attaching is one of a mounting plate, a hangar, a bumper and combinations thereof.

20. The tray as in claim 19, further comprising a bar attachable to the cart, the hangar attachable to the bar.

21. The tray as in claim 18, further comprising a gate configured for opening the basket.
